(19) United States
(12) Patent Application Publication
(10) Pub. No.: US 2005/0015772 A1
(43) Pub. Date: Jan. 20, 2005

(54) Method and system for device specific application optimization via a portal server

(76) Inventors: John E. Saare, Lakeport, CA (US); Thomas R. Mueller, Fremont, NE (US)

Correspondence Address: OSHA & MAY L.L.P./SUN, 1221 MCKINNEY, SUITE 2800, HOUSTON, TX, 77010, US

(21) Appl. No.: 10/622,032

(22) Filed: Jul. 16, 2003

(51) Int. Cl. G06F 3/00

(52) U.S. Cl. 719/310

(57) ABSTRACT

Embodiments of the present invention are directed to a method and system for device specific optimization of applications via a portal server. In one embodiment, a plurality of applications are resident upon a portal server. A plurality of application helper modules are respectively associated with each of the plurality of applications. Based upon the device type of a device requesting access to the portal server, an appropriate application helper is selected. When portal server requests a function to performed by the appropriate application helper module, the application helper module provides a link to the particular application. The portal server then displays the link to the particular application within a user-customizable display. The function requested can be to launch the application, or to perform some sub-process of the application.

### FIELD OF THE INVENTION

Embodiments of the present invention relate to the field of Web portal servers and software and communication with these services and a variety of user devices.

### BACKGROUND OF THE INVENTION

A web portal is a term for a user customized World Wide Web site whose purpose is to be a starting point for users when they connect to the Web. There are general portals and specialized or niche portals that are typically focused upon a specific topic. Private niche portals are used by companies to help disseminate information to their employees in a timely and efficient manner. Web portal services, sometimes referred to as “channels” typically include a search engine or directory, news, sports, weather, electronic mail (e-mail), stock quotes, maps, forums, chat, shopping, and options for customization. These are only some of the most frequently offered services; large portals often include dozens or hundreds of bundled services. Private portals often include access to payroll information, internal phone directories, company news, and employee documentation. Web portals are implemented by running Web portal software on a server.

Web portals are generally used for the personalization and aggregation of online content. In the context of web portals, personalization refers to the ability of end users to customize their content and experience with the portal. Aggregation refers to the ability for the site to collect data and content from other sites or other services. Thus, web portals facilitate collecting content together and presenting it to users in a way that is efficient and can be personalized.

Typically, web portal developers design their sites to be compatible with desktop computers because they are the devices used by the majority of users accessing the Internet. Thus, the content of the portal is typically formatted for that environment. For example, a web portal that can be viewed upon a desktop computer having a minimum display resolution of 600×800 pixels and running one of the most widely used operating systems and web browsers is usually sufficient for most developers. The designers typically assume the desktop computer uses a mouse and an alpha-numeric keyboard as the user input devices. As a result, entire pages of content (e.g., an e-mail message) that can be displayed upon a desktop computer often cannot be displayed in a usable manner upon mobile devices such as cellular telephones or PDAs.

Recent technology trends have allowed mobile access of web content on the Internet using cellular telephones, laptop computers, and personal digital assistants (PDAs). As a result, there is a greater demand for online content that is accessed by mobile devices. However, many users are finding it difficult, if not impossible, to access the same web content using mobile devices that they can access with their desktop computers. In other words, the web content that is designed for display on a desktop computer is often not accessible or is incomprehensible using a mobile device.

There are a variety of factors that prevent properly displaying web content on mobile devices. For example, the transmission rate for many mobile devices is limited to approximately 9600 baud. This restricts, for example, the ability of mobile devices to display streaming content. Additionally, mobile devices, particularly cell phones, are limited in the amount of available memory with which they can store downloaded data. Also, mobile devices use a variety of markup languages to describe how the content should be displayed. Typically, websites are written in hypertext markup language (HTML), however, cellular telephones typically utilize wireless markup language (WML) and some PDAs use yet another. As a result, the cellular telephones typically cannot display the website's content in a usable manner to the user.

In the mobile environment, there are thousands of individual device types which may be accessing the web portal and the various characteristics of the individual devices affect how the data is displayed. For example, the display for a cellular telephone is far smaller than the display for a PDA or laptop computer. Additionally, various mobile devices may have either black-and-white or color displays and may use different methods for displaying text and/or graphics (e.g., using bitmaps, or vector graphics for displaying text). As a result, some web content may be displayed in a manner that is incomprehensible to the users accessing the content.

User input devices also vary depending on the particular mobile device being used. For example, cellular telephones typically input text using keypad sequences and provide limited capability for navigating and interacting with displayed content. PDAs and laptop computers utilize more capable input devices such as touch screens, track-balls, joystick controllers, and alpha-numeric keypads. Thus, user input that can be easily accomplished on a PDA or laptop computer may be tedious, time consuming, and error prone for cellular telephone users.

As stated above, application and web portal developers designed their product to be compatible with a desktop computer having certain minimum requirements. This was economically feasible in that they could assume they were accessible to a majority of users who were trying to access their content. However, it is not economically feasible for application and/or web portal developers to create a different product for each possible environment in the mobile market.

As a result, users who can access web channels from their desktop computers may find it difficult or burdensome to access the same web channels from a mobile device. Additionally, the limited capabilities of some mobile devices make it difficult or burdensome for some users to edit their application preferences using their mobile devices.

### SUMMARY OF THE INVENTION

Accordingly, a need exists for a method and system that allows device specific optimization of applications accessed via a web portal server. While meeting the above stated need, it would be advantageous for such a system to facilitate editing user preferences of applications that is device specific as well.

Embodiments of the present invention are directed to a method and system for device specific optimization of applications via a portal server. In one embodiment, a plurality of applications are resident upon a plurality of servers (e.g., a portal server) portal server. A plurality of application helper modules are respectively associated with each of the plurality of applications. Based upon the device type of a device requesting access to the portal server, an appropriate application helper is selected. When portal server requests a function to be performed by the appropriate application helper module, the application helper module provides a link to the particular application for implementing the function. The portal server then displays the link to the particular application within a user-customizable display.

In one embodiment, a family of classes are implemented that incorporate logic that performs the following operations: 1) generate URLs that activate functionality of a particular web application; and 2) assist in the generation of a graphical user interface that permits manipulation of preferences pertaining to that web application. These classes (e.g., Java classes) are called application helpers.

In accordance with an embodiment of the present invention, a framework is described within the context of a collection of portal providers, that manages and activates an application helper in such a fashion that: 1) the correct application helper is selected to permit the manipulation of application preferences, independent of the device from which the application will be accessed; and 2) the correct application helper is selected, to permit access to the web application best suited to the device from which the request is being made.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 is a block diagram of an exemplary computer system upon which embodiments of the present invention may be utilized.

FIG. 2 is a block diagram of an exemplary computer network upon which embodiments of the present invention may be utilized.

FIG. 3 is a block diagram of an exemplary network framework used in embodiments of the present invention.

FIG. 4A is a data flow diagram of a plurality of software applications and application helper modules utilized in accordance with embodiments of the present invention.

FIG. 4B is a data flow diagram of a plurality of software applications and application helper modules in accordance with embodiments of the present invention.

FIG. 5 is a flowchart of a computer implemented method for presenting information on a network system in accordance with embodiments of the present invention.

FIG. 6 is a flowchart of a computer implemented method for device specific optimization of applications via a portal server in accordance with embodiments of the present invention.

FIG. 7 is a data flow diagram showing responses to function requests in accordance with embodiments of the present invention.

### DETAILED DESCRIPTION OF THE PREFERRED EMBODIMENT

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining,” “sending,” “requesting,” “selecting,” “responding,” “providing,” “displaying,” “launching,” “modifying,” “editing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

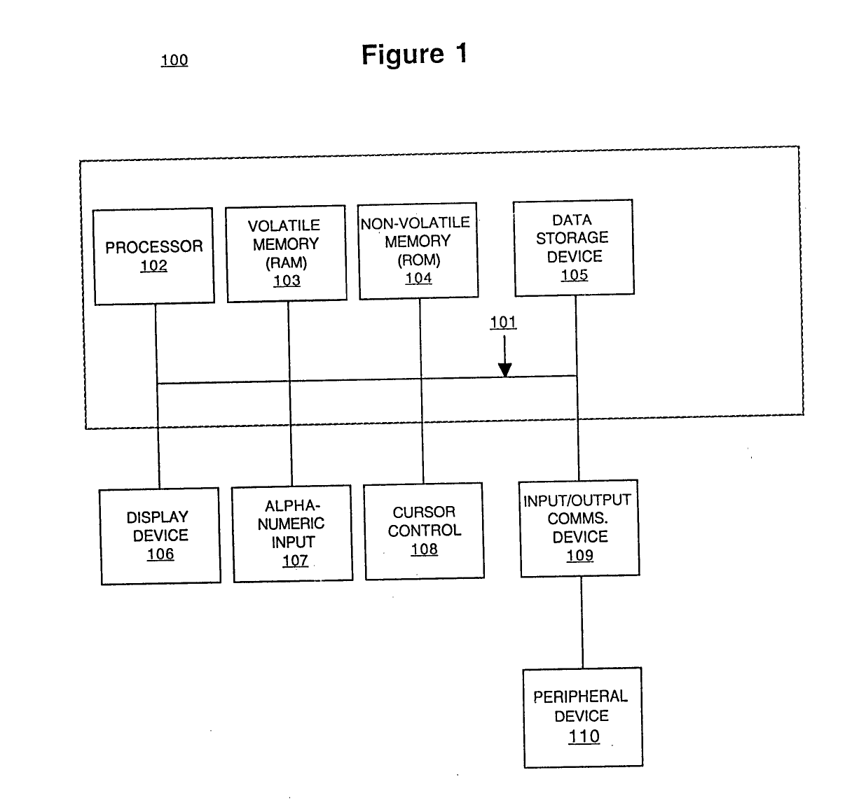

With reference to FIG. 1, portions of the present invention are comprised of computer-readable and computer-executable instructions that reside, for example, in computer system 100 which is used as a part of a general purpose computer network (not shown). It is appreciated that computer system 100 of FIG. 1 is exemplary only and that the present invention can operate within a number of different computer systems including server computer systems, general-purpose computer systems, embedded computer systems, laptop computer systems, hand-held computer systems, and stand-alone computer systems, etc.

In the present embodiment, computer system 100 includes an address/data bus 101 for conveying digital information between the various components, a central processor unit (CPU) 102 for processing the digital information and instructions, a volatile main memory 103 comprised of volatile random access memory (RAM) for storing the digital information and instructions, and a non-volatile read only memory (ROM) 104 for storing information and instructions of a more permanent nature. In addition, computer system 100 may also include a data storage device 105 (e.g., a magnetic, optical, floppy, or tape drive or the like) for storing vast amounts of data. It should be noted that the software program for performing a method for device specific application optimization via a portal server of the present invention can be stored either in volatile memory 103, data storage device 105, or in an external storage device (not shown).

Devices which are optionally coupled to computer system 100 include a display device 106 for displaying graphic images, alpha-numeric characters, and other information to a computer user, an alpha-numeric input device 107 (e.g., a keyboard), and a cursor control device 108 (e.g., mouse, trackball, light pen, etc.) for inputting data, selections, updates, etc. Computer system 100 can also include a mechanism for emitting an audible signal (not shown).

Furthermore, computer system 100 can include an input/output (I/O) signal unit (e.g., interface) 109 for interfacing with a peripheral device 110 (e.g., a computer network, modem, mass storage device, etc.). In embodiments of the present invention, device 109 may be a network interface card or NIC device. Accordingly, computer system 100 may be coupled in a network, such as a client/server environment, whereby a number of clients (e.g., personal computers, workstations, portable computers, minicomputers, terminals, PDAs, cellular telephones, etc.) are used to run functions for performing desired tasks (e.g., initiating applications and/or editing application preferences, etc.). In particular, computer system 100 can be coupled in a system for device specific application optimization via a portal server.

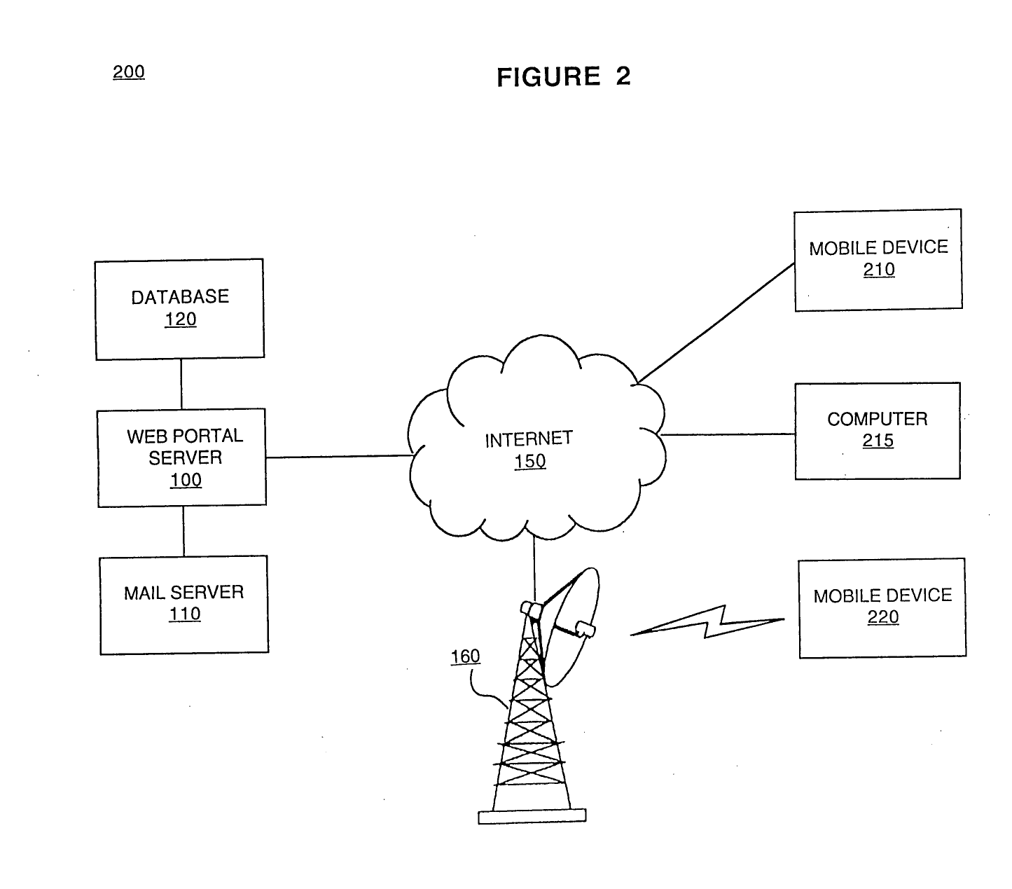

FIG. 2 is a block diagram of an exemplary computer network 200 upon which embodiments of the present invention may be utilized. In FIG. 2, a portal server 100 is coupled with Internet 150. In embodiments of the present invention, portal server 100 is similar to the above described computer system 100 of FIG. 1 and runs software for implementing a web portal. Portal server 100 may be a stand alone system, or may be coupled in a network with other components. For example, in FIG. 2, portal server 100 is coupled with database 120 and with mail server 110. Portal server 100 is further coupled with mobile devices 210 and 220 and computer 215 via Internet 150. While the present embodiment shows portal server 100 coupled with Internet 150, embodiments of the present invention are well suited to be coupled in other communication networks such as local area networks (LANs), wide area networks (WANs), etc. As shown in FIG. 2, mobile device 210 and computer 215 are communicatively coupled with Internet 150. Mobile device 210 may be any type of electronic device such as a laptop computer, PDA, cellular telephone, pager, or other device that can be communicatively coupled with Internet 150. Computer 215 may be a personal computer, or similar device that can be communicatively coupled with Internet 150. In embodiments of the present invention mobile device 210 and computer 215 are coupled with Internet 150 using the public switched telephone network (PSTN), or use a dedicated high speed connection such as cable Internet, a digital subscriber loop (DSL), etc. Also shown in FIG. 2 is mobile device 220 which is wirelessly coupled with Internet 150 via a wireless provider 160. Again, mobile device 220 may be a laptop computer, a PDA, a cellular telephone, or other device that can be wirelessly coupled with Internet 150. It is appreciated that embodiments of the present invention are well suited to be used with

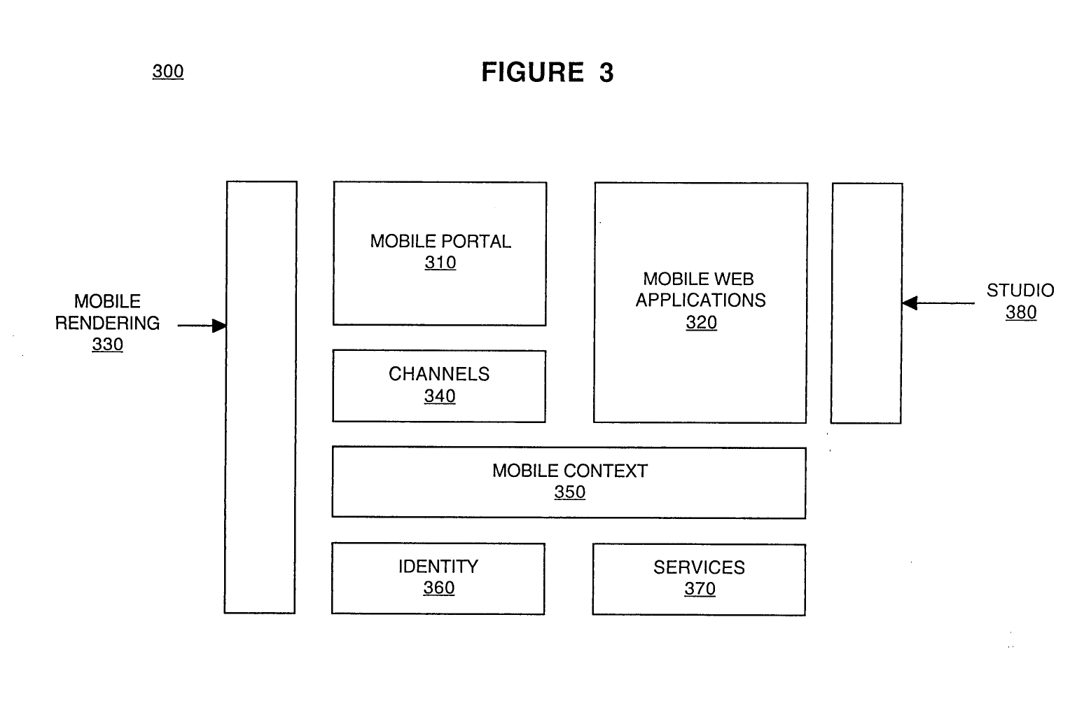

FIG. 3 is a block diagram of an exemplary network framework 300 used in embodiments of the present invention. It is appreciated that the network framework shown in FIG. 3 is exemplary and that embodiments of the present invention may be implemented in network frameworks of various configurations.

In the embodiment of FIG. 3, network framework 300 comprises a mobile portal module 310. Mobile portal module 310 displays the homepage for authorized mobile devices accessing the Internet using a web portal (e.g., web portal server 100 of FIG. 2) and is where users typically first interact with the web portal. Channels, representing different data services are displayed in the web portal and can be selected based upon user preferences. Mobile portal 310 provides a “micro-desktop” environment that is optimized for various mobile devices that are connecting with the Internet via web portal server 100 as well as a standard desktop environment for desktop computer systems that are accessing the Internet via web portal server 100.

Network framework 300 further comprises a mobile web applications module 320. Mobile web applications module 320 provides a standard user interface to application logic that is formatted for desktop computers, as well as a separate “micro-user interface” for mobile devices to application logic that is formatted for mobile devices. Mobile web applications module 320 may provide other user interfaces for other operating environments as well. For example, a “voice-user interface” could be provided to facilitate voice control of application logic.

Network framework 300 further comprises a mobile rendering module 330. In the embodiment of FIG. 3, mobile rendering module 330 is responsible for determining the device type of the mobile device accessing web portal server 100 and for presenting content in a usable fashion to that device. For example, mobile rendering module 330 is responsible for determining what type of client device is accessing web portal server 100. Mobile rendering module 330 may determine the manufacturer, and model number of the mobile device (e.g., mobile device 210 of FIG. 2) accessing web portal server 100. Using this information, web portal server 100 can access a database (e.g., database 120 of FIG. 2) to get more specific information about mobile device 210 such as the display size and whether it supports color, buffer size, markup language, type of input device used, etc. The information about mobile device 210 may be specific to that device only, or may be associated with a class of devices having substantially similar characteristics.

Mobile rendering module 330 also handles pagination of content delivered to mobile devices. Because of limitations in the buffer size or screen size of various mobile devices, content that typically is sent to a desktop computer in one response may have to be sent to a mobile device as a series of discreet messages. Mobile rendering module 320 also translates HTML data into a markup language supported by the mobile device accessing web portal server 100.

Network framework 300 further comprises a channels module 340. Channels module 340 collects data for various services or channels that are displayed on the user's web portal homepage. In one embodiment, summary information about available channels is displayed on the user's homepage. For example, in an e-mail channel, the summary information may comprise the headers for the first 5 e-mails in the inbox. This simply informs the user that there is mail in the inbox. The user cannot view the mail or manipulate the e-mail application until they click the link to the e-mail channel.

Mobile context module 350 provides information that is shared by the applications and channels offered by web portal server 100 and sets up the environment in which they operate in a mobile context. For example, mobile enabling of e-mail has components in common with mobile enabling of a calendar program. Some of these components include device profiles such as screen size, buffer size, input mechanism, the number of bits-per-pixel (which indicates whether the display is color or black and white), and what languages are supported by the mobile device. In embodiments of the present invention, device specific information is stored in a device profile within mobile context module 350. Mobile context module 350 also provides service profiles that are specific to the mobile context. For example, a user may utilize a different web browser or e-mail program on their mobile device than the one they use with their desktop computer. Information in the service profile may include the mail server name, port number, login and password, etc.

Identity module 360 stores persistent data such as the user's credentials, log-in password, access privileges to various services, policy information, etc. Identity module 360 also provides a single sign-on capability so that a user does not have to log into various servers separately when, for example accessing e-mail or other web portal channels.

Services module 370 represents the services with which the mobile device can communicate (e.g., e-mail, calendar, address book, messaging, etc).

Studio module 380 provides a developer environment in which users can create custom applications, channels, and interfaces as well as emulators for viewing them on simulated desktops and/or mobile devices.

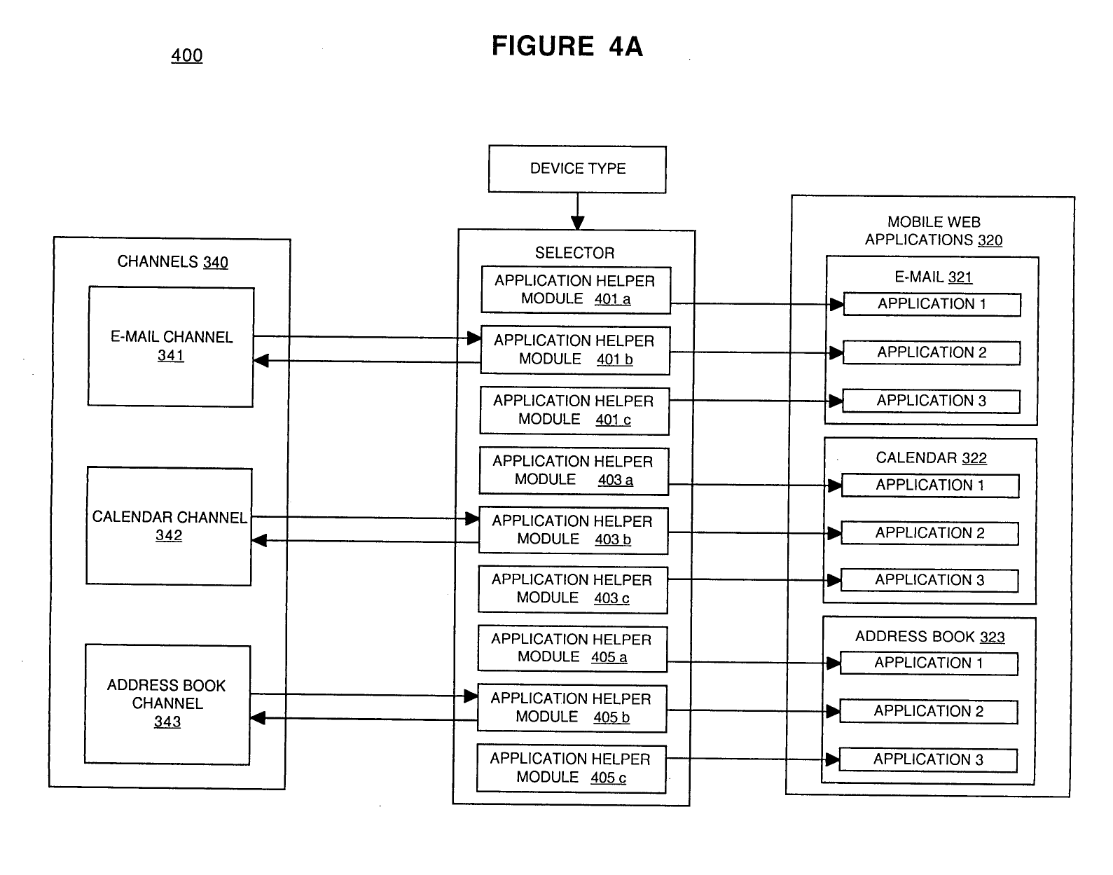

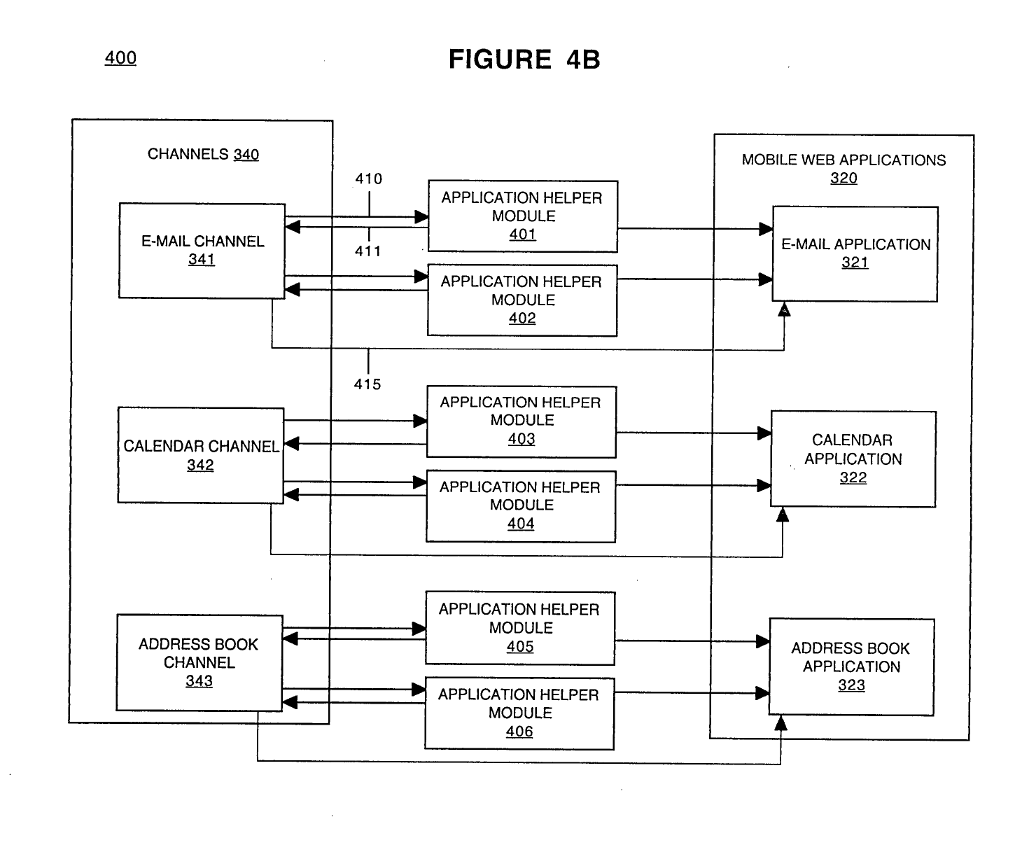

FIG. 4A is a data flow diagram of a plurality of software applications and application helper modules utilized in embodiments of the present invention. FIG. 4A shows a channels module (e.g., channels modules 340 of FIG. 3) comprising an e-mail channel (341), a calendar channel (342), and an address book channel (343). A mobile web applications module (e.g., mobile web applications module 320 of FIG. 3) is comprised of an e-mail application 321, a calendar application 322, and an address book application 323. In the embodiment of FIG. 4A, e-mail application 321 comprises a plurality of e-mail applications (e.g., applications 1, 2, and 3). Similarly, calendar application 322 and address book application 323 are comprised of a plurality of respective applications.

In one embodiment of the present invention, a family of classes are implemented that incorporate logic that performs the following operations: 1) generate URLs that activate functionality of a particular web application; and 2) assist in the generation of a graphical user interface that permits manipulation of preferences pertaining to that web application. These classes (e.g., Java classes) are called application helpers.

In accordance with embodiments of the present invention, framework 300 manages and activates an application helper in such a fashion that: 1) the correct application helper is selected to permit the manipulation of application preferences, independent of the device from which the application will be accessed; and 2) the correct application helper is selected, to permit access to the web application best suited to the device from which the request is being made.

Depending upon the type of device accessing the web portal server, a particular application helper module is selected. Each application helper module is associated with a particular implementation of a mobile web application. For example, one application helper module is associated with an e-mail application that is formatted to be displayed upon a cellular telephone. A second application helper module is associated with a second implementation of the same e-mail application that is formatted to be displayed upon a laptop computer. Alternatively, the second application helper module can be associated with a second e-mail application that is formatted to be displayed upon the laptop computer.

Thus, the application helper modules serve as an adapter between the web portal channels and the mobile web applications. Using embodiments of the present invention, the channels can access an associated application or service in a generic manner. In other words, application specific coding is not included in the coding that generates the channel on the web portal desktop in embodiments of the present invention. Instead, the application helper modules contain the coding for generating a URL that is used by the channel to perform the requested function.

Referring again to FIG. 4A a selector comprising a plurality of application helper modules is shown. In the embodiment of FIG. 4A, each application helper module is respectively associated with a particular application. For example, application helper modules 401a, 401b, and 401c are associated with e-mail applications 1, 2, and 3 respectively. Similarly, application helper modules 403a, 403b, and 403c are associated with calendar applications 1, 2, and 3 respectively and application helper modules 405a, 405b, and 405c are associated with address book applications 1, 2, and 3 respectively. While the present embodiment recites these applications specifically, embodiments of the present invention are well suited to be used with other types and combinations of web based services and applications as well.

A user attempting to access his/her address book selects the address book 343 displayed by the web portal site. A function request is generated and the type of device with which the user is attempting to access the address book application is determined (e.g., using mobile rendering module 330 of FIG. 3). The selector then selects the appropriate application helper module (e.g., application helper module 405b) to perform the requested function. When a different type of mobile device attempts to access the web portal server, a different application helper module (e.g., application helper module 405a, or 405c) may be used to access the respective address book application appropriate for that device type. Thus, using the present invention, address book channel 343 can access the address book applications without having to be modified specifically for a particular application and without knowledge of which application helper module with which it is communicating. Referring again to FIG. 4A, when the user selects the e-mail or calendar channels using the same mobile device used to access address book application 2, application helper modules 401b or 403b is selected respectively.

Referring now to FIG. 4B, application helper modules 401 and 402 are associated with e-mail channel 241 and with e-mail application 321. Similarly, application helper modules 403 and 404 are associated with calendar channel 242 and with calendar application 322, and application helper modules 405 and 406 are associated with address book channel 243 and with address book application 323. While the embodiment of FIG. 4B shows two application helper modules associated with a particular channel and application, it is appreciated that one or more application helper modules may be associated with a particular channel and application in embodiments of the present invention.

In embodiments of the present invention, a particular application helper module is selected depending upon the device type of the device accessing the web portal server. As described above, in embodiments of the present invention network framework 300 is capable of determining the type of device accessing the web portal server. Based upon this information, a particular application helper module is selected to link a given channel with a particular application. The application helper modules are comprised of custom coding for generating URLs that activates an application or service in a specific manner that is optimized for the device accessing the web portal. The application helper modules act as an adapter between the coding of the web portal channels and the underlying applications and services. In other words, the application helper modules of the present invention allow the channel on the desktop to interact with the application without having to include application specific coding within the channel coding. Additionally, the coding for the underlying services and applications does not have to be modified to adapt it to a mobile context.

For example, a particular application helper module is selected based upon the user interface and/or display capabilities of the device accessing the web portal server. Thus, a particular application helper module may be selected based upon a particular device type, or a class of devices having, for example, substantially similar user interface and/or display capabilities. However, while the present embodiment recites these parameters specifically, embodiments of the present invention are well suited to select application helper modules based upon a variety of device parameters. Other parameters may include, for example, the markup language used by the mobile device, the data bandwidth of the connection, the language being displayed, the buffer size of the mobile device, etc. As an example, an e-mail message may be sent to a cellular telephone as a series of discreet communications due to limitations in the buffer size and display capabilities of the cellular telephone. In embodiments of the present invention, service profile information such as server names for particular applications and services accessed (e.g., an e-mail server name), user authentication and password information are also used in selecting a particular application helper module.

Referring also to FIG. 2, application helper module 401 is selected when mobile device 210 is accessing web portal server 100 and application helper module 402 is selected when mobile device 220 is accessing web portal server 100. Thus, when the user of mobile device 210 accesses e-mail channel 341, a function request (e.g., event 410 of FIG. 4) is generated and application helper module 401 associated with the appropriate e-mail program generates the URLs (e.g., event 411 of FIG. 4) necessary for initiating an implementation of e-mail application 321 in a manner that is optimized for the device characteristics of mobile device 210. E-mail channel 341 then uses the URLs generated by the appropriate application helper module (e.g., event 415 of FIG. 4) to initiate e-mail application 321. Application helper module 401 can also return links to e-mail channel 341 for performing a specific sub-function of e-mail application 321 as requested by the channel. For example, a URL can be generated to allow a user to edit application preferences so that e-mail application is optimized to accommodate the display size, buffer size, input device type, markup language, etc. that are associated with mobile device 210. While the present embodiment recites these device characteristics specifically, other device characteristics may be used to optimize applications in embodiments of the present invention.

In embodiments of the present invention, the application helper modules allow a user to use different applications depending upon the mobile device being used to access the web portal. For example, a user may designate one e-mail application to be used when mobile device 210 is accessing web portal server 100 and a different e-mail application when mobile device 220 is accessing web portal server 100. This is advantageous when a user prefers one application when accessing content from, for example, a desktop computer and a different application when accessing the same content from a mobile device.

Prior web portal implementations made no provision for optimizing the application depending on the device accessing the web portal. Thus, content that was optimized for a desktop/HTML environment was often incomprehensible to user's of mobile devices such as cellular telephones and PDAs. In embodiments of the present invention, the application helper modules adapt the existing web applications and services so that their content is displayed in a usable manner on the user's mobile device. In so doing, no additional coding of web based applications existing on a web portal server is needed to allow access by users of mobile devices.

In embodiments of the present invention, a user can also invoke a specific sub-function of a web based application using an application helper module. For example, a user can select a specific appointment in their calendar application by selecting it from the summary information displayed in the web portal calendar channel. Referring again to FIG. 4, application helper module 403 can generate the URL for directly accessing a specific appointment in calendar application 322 in response to a user selection without having to navigate intervening levels of the application. The application helper module provides this link in response to a request for a specific function to be performed.

In embodiments of the present invention, one application sub-function that can be invoked is the application preferences editor. Depending upon the user interface of the device accessing the web portal server, a user may prefer not to edit their applications preferences using that device. For example, cellular telephone users may prefer not to edit their application preferences due to the limitations of the user interfaces that are found in most cellular telephones. However, PDA users may prefer to edit their application preferences because the user interface of a typical PDA can more readily facilitate this type of action. Therefore, in embodiments of the present invention, editing of application preferences is based upon the type of device accessing the web portal server. Thus, the application helper module that is associated with a cellular telephone can have the application preference editing feature disabled in embodiments of the present invention. For example, a request for a link to the preference editing function will result in the application helper module returning a null set to the mobile device. Other mobile devices, such as PDAs and/or laptop computers, can have the application preference editing feature enabled due to the more capable user interfaces typically found on these devices.

In embodiments of the present invention, the summary information displayed by the web portal channel can be determined by the device accessing the web application server. For example, the e-mail channel displayed upon a cellular telephone may only indicate that there are new messages in the e-mail inbox. Alternatively, the e-mail channel displayed upon a desktop computer may include more information such as the headers from messages in the e-mail inbox. This is possible because the application helper modules are selected based upon the type of device accessing the web portal channel.

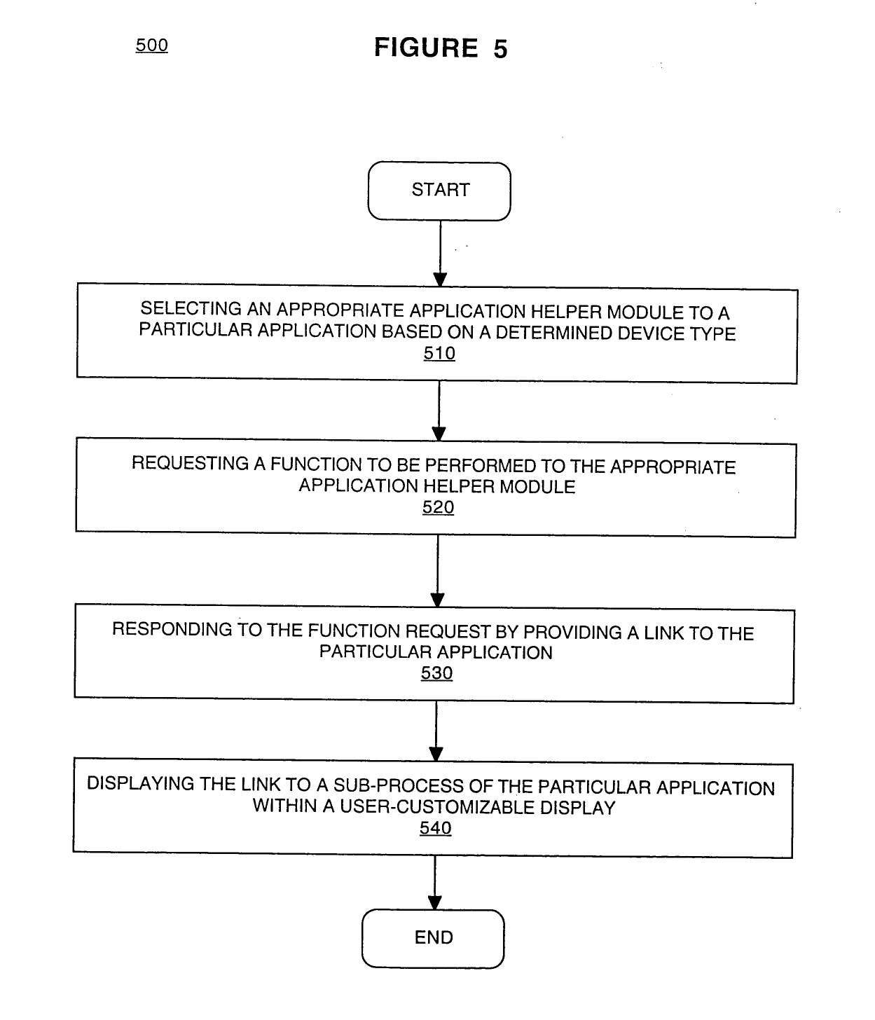

FIG. 5 is a flowchart of a method 500 for presenting information on a network system in accordance with embodiments of the present invention. In step 510 of FIG. 5, an appropriate application helper module associated with a particular application is selected based on a determined device type. In this manner, a particular application is selected based upon the device type of the device accessing the application. As described above, embodiments of the present invention are implemented in a network framework that identifies the type of device accessing the web portal server. Referring again to FIG. 3, one of the functions of mobile rendering module 330 is to determine the type of device accessing web portal server 100. Using this information, mobile context module 350 stores a device profile comprising, for example, the screen size, buffer size, input mechanism, markup language, of the device accessing web portal server 100. Additionally, a service profile may be stored in mobile context module comprising server names, user authentication and passwords, etc.

Depending upon the type of device accessing the web portal server, the present invention will select an appropriate application helper module that is associated with a particular application. Referring again to FIG. 4, application helper module 401, which is associated with e-mail channel 341 and with e-mail application 321, is selected based upon the characteristics of the device accessing web portal server 100.

In step 520 of FIG. 5, a function to be performed by an application is requested to the appropriate application helper module. Referring again to FIG. 4, a user requests launching e-mail application 321.

In step 530 of FIG. 5, a link to the particular application is provided by the application helper module in response to the function request. Referring again to FIG. 4, application helper module 401 generates a link for launching e-mail application 321 upon the device accessing web portal server 100. As discussed above, the application helper modules of the present invention facilitate customization of the display of content on a user device.

In step 540 of FIG. 5, the link to the particular application is displayed within a user-customizable display. The link to e-mail application 321 is displayed in the e-mail channel of the web portal page displayed upon the user's device. Activation of the link directly causes the appropriate e-mail program to activate, e.g., launch.

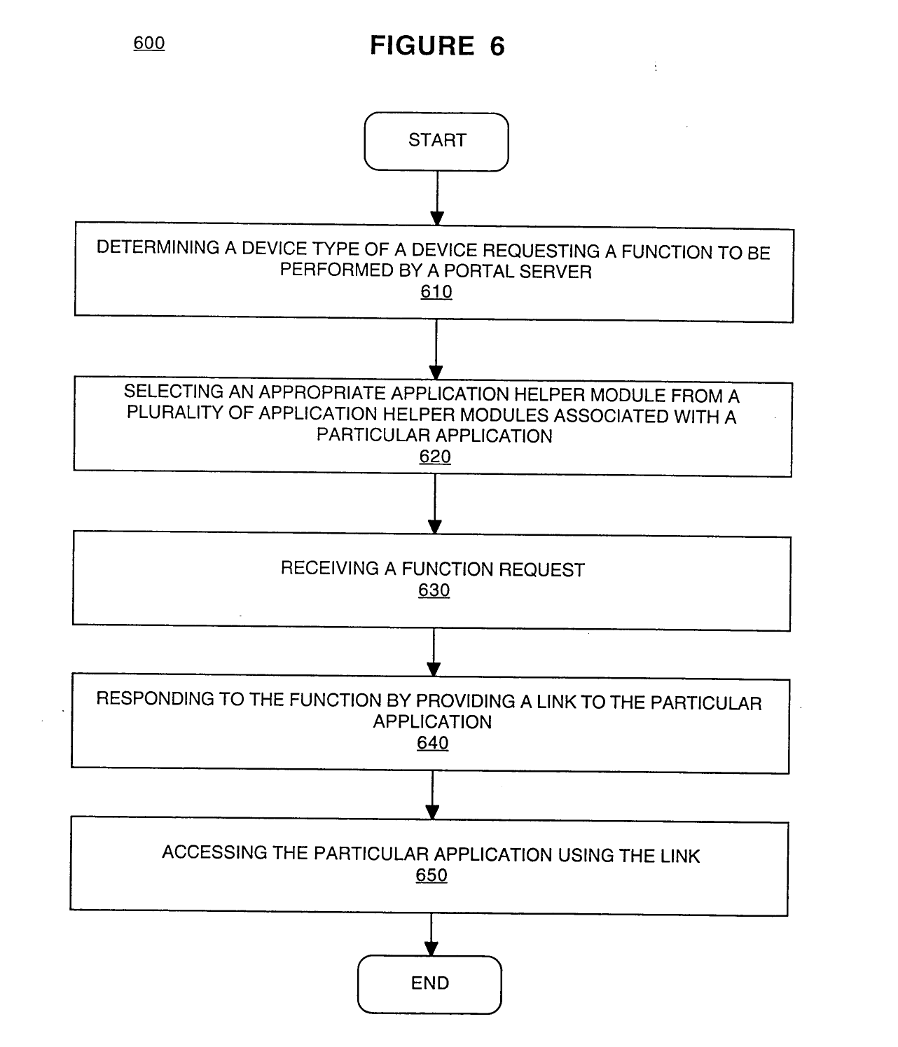

FIG. 6 is a flowchart of a method 600 for device specific optimization of applications via a portal server in accordance with embodiments of the present invention. In step 610 of FIG. 6, a device type of a device requesting a function to be performed by a portal server is determined. As described above, in embodiments of the present invention, network framework 300 comprises a mobile rendering module 330 that can detect the type of device accessing web portal server 100.

In step 620 of FIG. 6, an appropriate application helper module is selected from a plurality of application helper modules associated with a particular application. In embodiments of the present invention, a particular application helper module is selected based upon the type of device accessing the web portal server. Referring to FIG. 4, application helper module 403 is selected when mobile device 210 is accessing calendar application 322 via web portal server 100. When mobile device 220 is accessing calendar application 322 via web portal server 100, application helper module 404 is selected to generate the appropriate URLs.

In step 630 of FIG. 6, a function request is received. Referring again to FIG. 4B, application helper module 403 receives a request to display a record of the appointments for a particular day.

In step 640 of FIG. 6, the appropriate application helper module responds to the function request by providing a link to the particular application to perform the sub-function requested. In response to a function request by a user, the application helper modules of the present invention generate a URL to a web based application that is optimized for the device type of the device accessing the web portal server. This allows users of mobile devices to access content that can be displayed upon desktop computers to be viewed on mobile devices in a usable manner. For example, application helper module 403 generates a URL for an implementation of calendar application 322 that is optimized for mobile device 210. Similarly, application helper module 404 generates a URL for an implementation of calendar application 322 that is optimized for mobile device 220.

In step 650 of FIG. 6, the web portal server accesses the particular application using the link to obtain the requested record. Using the URL generated in step 630, the web portal server accesses the particular application requested by a user. For example, web portal server 100 will access calendar application 322 using a URL generated by application helper module 403 when mobile device 210 is the device accessing the calendar appointments. Web portal server 100 will access calendar application 322 using a URL generated by application helper module 404 when mobile device 220 is the device accessing the calendar appointments.

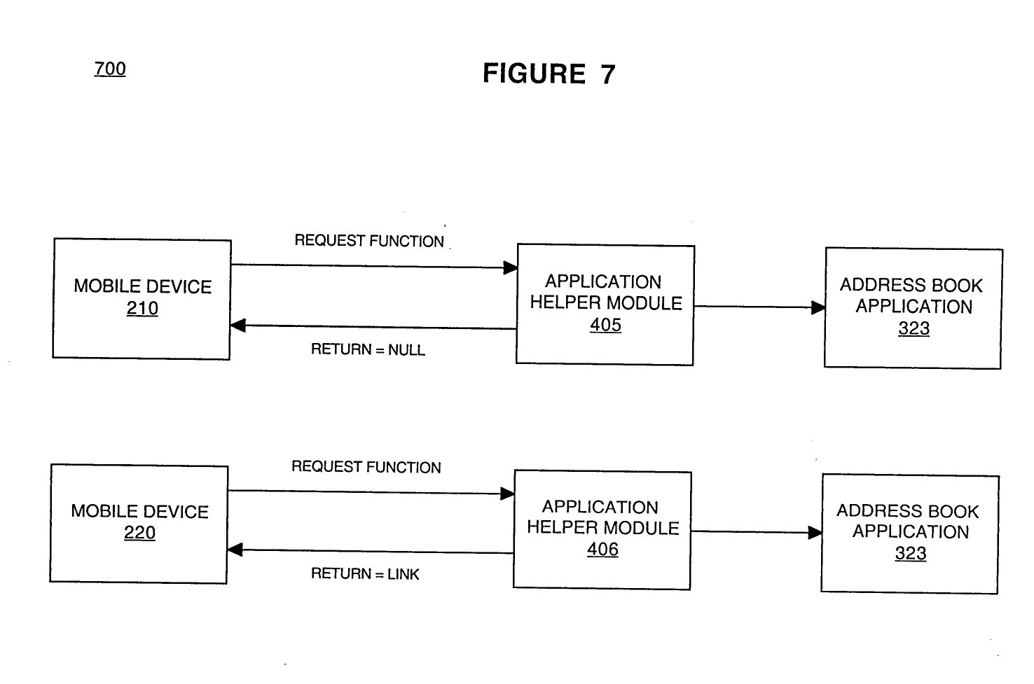

FIG. 7 is a data flow diagram showing responses to function requests in accordance with embodiments of the present invention. In the embodiment of FIG. 7, application helper module 405 is selected when a user is accessing address book application 323 using mobile device 210 (e.g., a cellular telephone). Application helper module 405 generates URLs for activating an implementation of address book application 323 that is optimized for mobile device 210. Application helper module 406 is selected when a user is accessing address book application 323 using mobile device 220 (e.g., a PDA). Application helper module 406 generates URLs for activating an implementation of address book application 323 that is optimized for mobile device 220. Depending upon the type of function being requested, an application module returns an appropriate link (e.g., a URL) to a mobile web application for implementing the requested function.

In the example of FIG. 7 a user of mobile device 210 (a cellular telephone) requests a function for editing application preferences for address book application 323. Because of the limited user interface and display capabilities of many cellular telephones, some functions, such as application preference editing may be tedious, time consuming, and error prone for many users. Therefore, application helper module 405 returns a null set response to mobile device 210 in response to the requested function of editing user preferences. The user of mobile device 210 may, for example, receive a message that preference editing is not an authorized operation for that device. Alternatively, because PDAs typically have more capable user interface and display capabilities, some users may desire to edit application preferences using their PDAs. Therefore, application helper module 406 returns a link that permits the user of mobile device 220 to activate the preference editing sub-function of address book application 323. Thus, the application helper modules facilitate tailoring application functionality to the type of mobile device accessing an application via a portal server.

The preferred embodiment of the present invention, a method and system for device specific application optimization via a portal server, is thus described. While the present invention has been described in particular embodiments, it should be appreciated that the present invention should not be construed as limited by such embodiments, but rather construed according to the following claims.

1. A system comprising:
a portal server for presenting a user customizable page comprising information and a plurality of links for invoking application functions;
a plurality of applications;
a plurality of application helper modules respectively associated with said plurality of applications, each application helper module for determining an application link to an associated application, wherein said link is of said plurality of links and is provided to said portal server in response to a function requested by said portal server and wherein said function is requested of said application helper module; and
a network framework for identifying a particular application helper module based on a determination of a device accessing said portal server.

2. A system as described in claim 1 wherein said particular application helper module is selected based on predetermined user interface capabilities of said device.

3. A system as described in claim 2 wherein said particular application helper module is associated with a particular application of said plurality of applications and wherein further said function requested by said portal server is to launch said particular application.

4. A system as described in claim 2 wherein said particular application helper module is associated with a particular application of said plurality of applications and wherein further said function requested by said portal server is to display information contained in a database record of said particular application.

5. A system as described in claim 2 wherein said particular application helper module is associated with a particular application of said plurality of applications and wherein further said function requested by said portal server is to modify preferences associated with said particular application.

6. A system as described in claim 5 wherein said link provided by said particular application helper module is null provided said particular application helper module restricts preference modification of said particular application.

7. A system as described in claim 2 wherein said particular application is an electronic mail application.

8. A system as described in claim 2 wherein said particular application is an electronic calendar application.

9. A system as described in claim 2 wherein said particular application is an electronic address book application.

10. A system as described in claim 1 wherein said particular application helper module is associated with a class of devices having substantially similar user interface capabilities.

11. A method for presenting information on a network system, said method comprising:
a) based on a determined device type of a device requesting access to a portal server, selecting an appropriate application helper module wherein said appropriate application helper module is associated with a particular application;
b) said portal server requesting a function to be performed of said appropriate application helper module;
c) said appropriate application helper module responding to said function by providing a link to said particular application; and
d) said portal server displaying said link to said particular application within a user-customizable display.

12. A method as described in claim 11 wherein said appropriate application helper module is selected based on predetermined user interface capabilities of said device requesting access to said portal server.

13. A method as described in claim 12 wherein said function requested by said portal server is to launch said particular application.

14. A method as described in claim 12 wherein said function requested by said portal server is to display information contained in a database record of said particular application.

15. A method as described in claim 12 wherein said function requested by said portal server is to modify preferences associated with said particular application.

16. A method as described in claim 15 wherein said link provided by said appropriate application helper module is null provided said appropriate application helper module restricts preference modification of said particular application.

17. A method as described in claim 12 wherein said particular application is an electronic mail application.

18. A method as described in claim 12 wherein said particular application is an electronic calendar application.

19. A method as described in claim 12 wherein said particular application is an electronic address book application.

20. A method as described in claim 11 wherein said appropriate application helper module is associated with a class of devices having substantially similar user interface capabilities.

21. A method for device specific optimization of applications via a portal server comprising:
determining a device type of a device requesting a function to be performed by a portal server;
selecting an appropriate application helper module from a plurality of application helper modules associated with a particular application, wherein said appropriate application helper is selected based upon said device type of the device requesting said function;
receiving a function request;
said appropriate application helper module responding to said function by providing a link to said particular application; and
said portal server accessing said particular application using said link.

22. A method as described in claim 21 wherein said appropriate application helper module is selected based on predetermined user interface capabilities of said device requesting access to said portal server.

23. A method as described in claim 22 wherein said function requested by said portal server is to launch said particular application.

24. A method as described in claim 22 wherein said function requested by said portal server is to display information contained in a database record of said particular application.

25. A method as described in claim 22 wherein said function requested by said portal server is to modify preferences associated with said particular application.

26. A method as described in claim 25 wherein said link provided by said appropriate application helper module is null provided said appropriate application helper module restricts preference modification of said particular application.

27. A method as described in claim 22 wherein said particular application is an electronic mail application.

28. A method as described in claim 22 wherein said particular application is an electronic calendar application.

29. A method as described in claim 22 wherein said particular application is an electronic address book application.

30. A method as described in claim 21 wherein said appropriate application helper module is associated with a class of devices having substantially similar user interface capabilities.
